(19) United States
(12) Patent Application Publication
(10) Pub. No.: US 2017/0097717 A1
(43) Pub. Date: Apr. 6, 2017

(54) ADVISORY TIME KEEPING DEVICE AND METHOD

(71) Applicant: Cubester LLC, Dayton, OH (US)

(72) Inventors: Sabitha Anisetti, Englewood, OH (US); William Stager, Oakwood, OH (US); Douglas L. Oda, Lewisburg, OH (US)

(21) Appl. No.: 15/273,118

(22) Filed: Sep. 22, 2016

Related U.S. Application Data
(60) Provisional application No. 62/236,885, filed on Oct. 3, 2015.

(51) Int. Cl. G06F 3/041; G04G 9/00; G04F 3/06; G06F 3/0346

(52) U.S. Cl. CPC G06F 3/0416; G06F 3/0346; G06F 3/0412; G04G 9/0064; G04F 3/06; G04G 13/02

(57) ABSTRACT

In some embodiments, an advisory time keeping device may include a housing having a controller, a control input, a display output, and a tilt sensor. The controller may include a timer module and a memory. The control input may be operable to enter time data and advisory data into the memory. A display output may be coupled to the housing which may be operable for displaying data from the timer circuit and memory. The tilt sensor may be in communication with the controller, and the tilt sensor may be operable to detect changes in the orientation of the housing. The controller may be operable to cause the display output to display advisory data in response to changes in the orientation of the housing which may be detected by the tilt sensor.

### CROSS REFERENCE TO RELATED APPLICATIONS

This application claims priority to and the benefit of the filing date of U.S. Provisional Application No. 62/236,885, filed on Oct. 03, 2015, entitled “NOVEL TIME KEEPING DEVICE”, which is hereby incorporated by reference in its entirety.

### FIELD OF THE INVENTION

This patent specification relates to the field of timer devices and methods. More specifically, this patent specification relates to timer devices and methods which are configured to receive and provide time data and advisory data.

### BACKGROUND

Timers and time countdown devices are typically configured to countdown one or more periods of time and to provide a notification upon the expiration of the time periods. While there are timers available in the market, they are unable to provide for a clear message that conveys the purpose for which the timer in counting down. For example, current timers are unable to provide specific information such as ‘Task name’ or ‘Availability message’ to let other people know that a person may be using a timer to focus on a task and need to keep all unnecessary distractions at bay until task completion.

Additionally, current timers in the market are unable to provide a message to people wishing to interact with the user who need to know whether or not the user of the timer is willing to be distracted. For this reason currently available timers are unable to help people wishing to interact with the user to know when to abstain from interacting with the user in order to respect the mental peace and space needed by the user to focus on a given task.

Furthermore, current timers in the market do not log in the details or information of when the timer was set and what message was broadcasted. Without this information, a user is less likely to understand their productive periods over a certain period of time, such as a day, week, month, for example.

Therefore, a need exists for novel timer devices and methods. There is a further need for novel timer devices and methods which are able to provide advisory data. Finally, there exists a need for novel advisory time keeping devices and methods which are configured to help people wishing to interact with the user of the device to know when to abstain from interacting with the user in order to respect the mental peace and space needed by the user to focus on a given task.

### BRIEF SUMMARY OF THE INVENTION

An advisory time keeping device is provided which may receive and provide time data and advisory data to help people wishing or needing to interact with the user of the device to know when to abstain from interacting with the user in order to respect the mental peace and space needed by the user to focus on a given task. In some embodiments, the device may include a housing having a controller, a control input, a display output, and a tilt sensor. The controller may include a timer module and a memory. The control input may be operable to enter time data and advisory data into the memory. A display output may be coupled to the housing which may be operable for displaying data from the timer circuit and memory. In further embodiments, there may be more than one display output relaying the information to different users. The tilt sensor may be in communication with the controller, and the tilt sensor may be operable to detect changes in the orientation of the housing. The controller may be operable to cause the display output to display advisory data in response to changes in the orientation of the housing which may be detected by the tilt sensor.

In further embodiments, the tilt sensor may be operable to detect a change in the orientation of the housing in a first axis and/or in a second axis.

In further embodiments, the device may comprise a TAPS sensor in communication with the controller, and the TAPS sensor may be operable to receive touch input such as a touch, bump or certain amount of force applied at a point on a corner, edge or side of the housing by a user.

In further embodiments, the device may be operable via a Universal Serial Bus(USB). The USB maybe in communication with a Graphic User Interface. A user or multiple users may display output on the device through entering time data and advisory data via USB controller connected to a personal computer.

In further embodiments, the device may be operable via a wireless connection. The controller may be in connection with another electronic device communicate time data and/or advisory data through wireless technologies available in the market with the electronic device.

In further embodiments, the controller may send time data and/or advisory data to one or more memory chips in wired connection with a user control input, such as a USB type or the like memory drive. This data may then be extracted to cloud storage via wireless communication and/or through the wired, preferably USB type, connection.

According to another aspect consistent with the principles of the invention, a method of providing advisory time keeping with an advisory time keeping device is provided. The method may include providing advisory data to the advisory time keeping device; tilting the housing of the device in a first axis to provide time data to the device; counting down the time data by the device; tilting the housing of the device in a second axis to display advisory data on the display output of the device; and providing a notification when the time data is completely counted down.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a perspective view of an example of an advisory time keeping device according to various embodiments described herein.

FIG. 2—FIG. 2 illustrates a front elevation view of an example of an advisory time keeping device according to various embodiments described herein.

FIG. 3—FIG. 3 shows a block diagram showing some of the elements of an example of an advisory time keeping device according to various embodiments described herein.

FIG. 4—FIG. 4 depicts a flow chart showing an example of a logic sequence used by an advisory time keeping device according to various embodiments described herein.

FIG. 5—FIG. 5 illustrates a block diagram of an example of a method of providing advisory time keeping according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

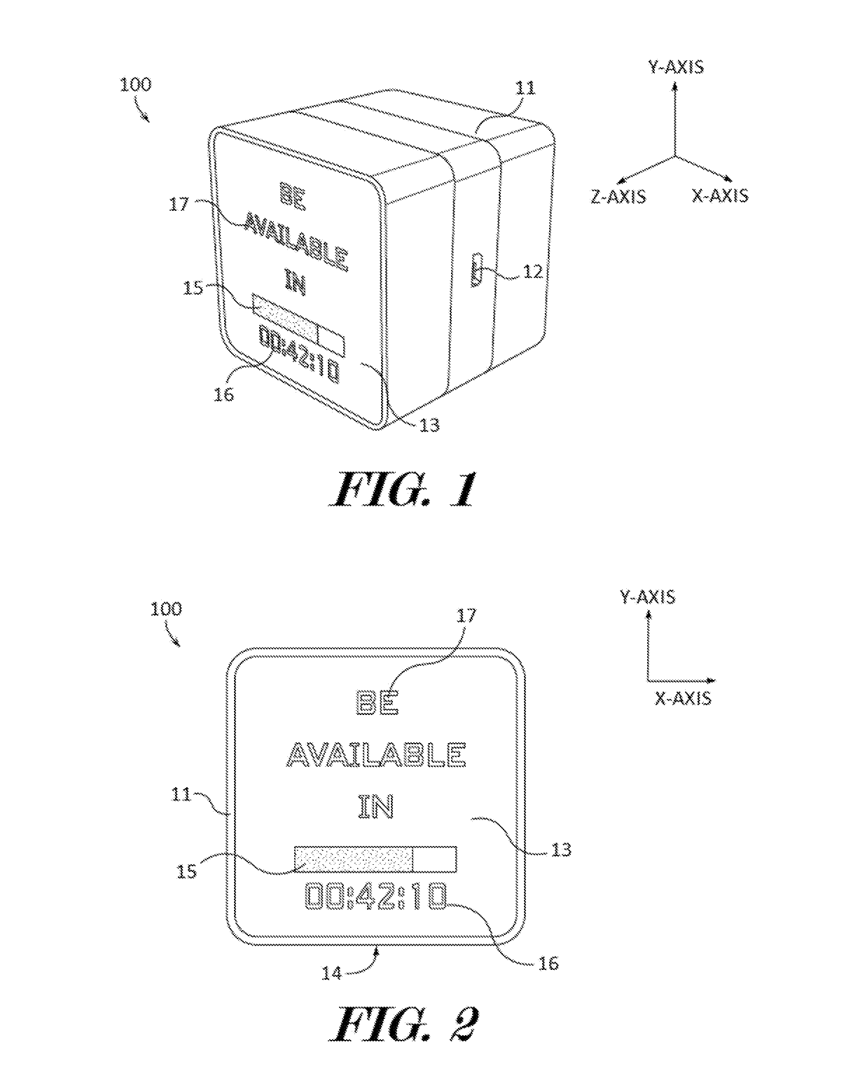

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

New timer devices and methods which are configured to receive and provide timer data and advisory data are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIGS. 1 and 2 illustrate an example of an advisory time keeping device (“the device”) 100 according to various embodiments. In this example and in some embodiments, the apparatus 100 may comprise a housing 11, a control input 12, and one or more display outputs 13. The control input 12 and one or more display outputs 13 may be coupled to the housing 11. The housing 11 may provide an enclosure for elements of the device 100 while also maintaining the positioning of the elements relative each other.

Preferably, the housing 11 may comprise one or more support surfaces 14 which may form an interface between the housing 11 and an object or surface upon which the device 100 may be supported. The one or more support surfaces 14 may support the device 100 in a level orientation which may be generally perpendicular to the force of gravity. In some embodiments, the housing 11 may be configured in the shape of a cuboid with one substantially planar surface of the cuboid forming a support surface 14. In other embodiments, the housing may be configured in any shape and comprise one or more support surfaces 14, such as which may be formed by one or more feet, pylons, struts, wheels, protrusions, and the like, which may be positioned on the housing 11 to support the device 100 in a level orientation which may be generally perpendicular to the force of gravity. It should be understood to one of ordinary skill in the art that the housing 11 and one or more support surfaces 14 may be configured in a plurality of sizes and shapes including “T” shaped, “X” shaped, square shaped, rectangular shaped, cylinder shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

In some embodiments, the housing 11 and one or more support surfaces 14 may be made from or comprise any substantially rigid material, such as steel alloys, aluminum, aluminum alloys, copper alloys, any other type of metal or metal alloy, any type of ceramic, earthenware, natural stone, synthetic stone, various types of hard plastics, such as nylon, acrylic, uPVC, HDPE, melamine, hard rubbers, fiberglass, carbon fiber, resins, such as epoxy resin, wood or any other material including combinations of materials that are substantially rigid. In preferred embodiments, the housing 11 and/or one or more support surfaces 14 may be made from a substantially resilient material such as silicone. In further embodiments, the housing 11 and/or one or more support surfaces 14 may be made from or comprise any substantially resilient material, such as silicone foams, silicone rubber, rubber foams, urethane foams, plastic foams, neoprene foam, latex foam rubber, polyurethane foam rubber, or elastomer materials such as elastic plastics, elastic silicone, elastic rubbers, or any other suitable elastomer or resilient material including combinations of materials. In further embodiments, all or portions of the housing 11 may be made from or comprise any type of glass, plexiglass material, other transparent or translucent materials, or the like which may optionally have an anti-glare coating.

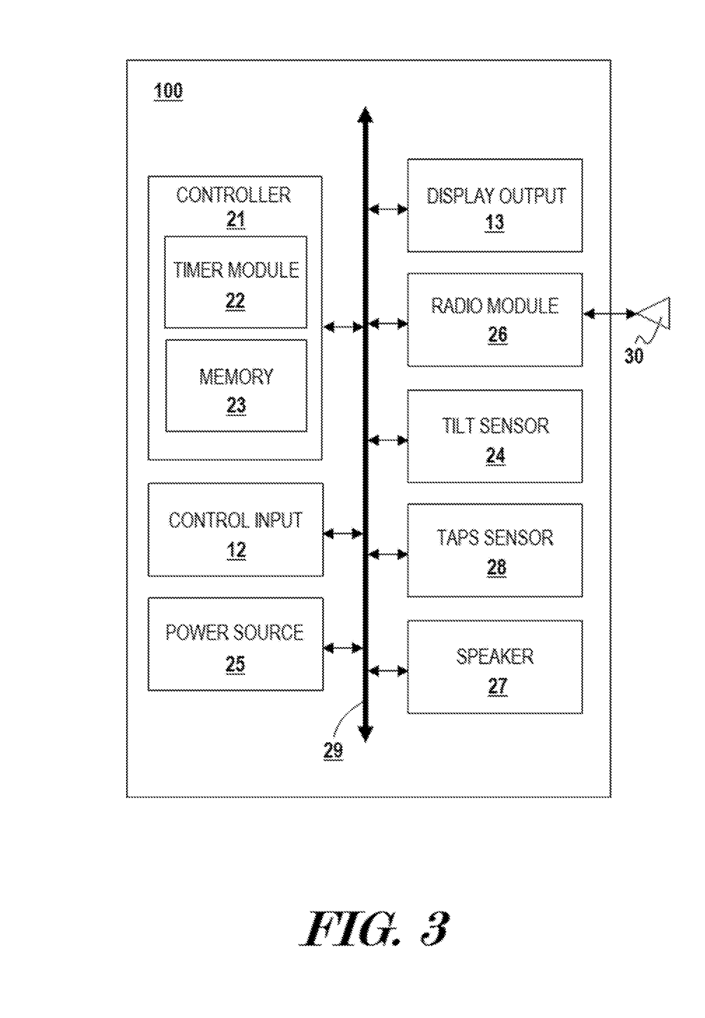

Turning now to FIG. 3, a block diagram showing some of the elements of an example of an advisory time keeping device according to various embodiments described herein is depicted. In some embodiments, the device 100 may comprise a controller 21 with a timer module 22 and a memory 23, a control input 12, and a display output 13. In further embodiments, the device 100 may also comprise one or more optional elements which may include a tilt sensor 24, a power source 25, a radio module 26 a speaker 27, and/or a TAPS sensor 28. The elements (12, 13, 21, 22, 23, 24, 25, 26, 27, 28) may be coupled to and/or within the housing 11.

A local interface 29 may provide electronic communication between one or more of the elements (12, 13, 21, 22, 23, 24, 25, 26, 27, 28). The local interface 29 can be, for example but not limited to, one or more buses or other wired or wireless connections, as is known in the art. The local interface 29 can have additional elements, which are omitted for simplicity, such as controllers, buffers (caches), drivers, repeaters, and receivers, among many others, to enable communications. Further, the local interface 29 may include address, control, and/or data connections to enable appropriate communications among the aforementioned components.

In preferred embodiments, a local interface 29 may be an integrated circuit (IC) that integrates one or more elements (12, 13, 21, 22, 23, 24, 25, 26, 27, 28) on a single chip sometimes called a system on a chip (SoC) or system on chip (SOC). In further preferred embodiments, a local interface 29 and one or more elements (12, 13, 21, 22, 23, 24, 25, 26, 27, 28) may be a microcontroller (or MCU, short for microcontroller unit) which may be a small computer (SoC) on a single integrated circuit containing a processor, memory 23, and a timer module 22. Program memory in the form of Ferroelectric RAM, NOR flash or OTP ROM is also often included on chip, as well as a typically small amount of RAM. Mixed signal microcontrollers are common, integrating analog components needed to control non-digital electronic systems.

In alternative embodiments, a local interface 29 may comprise a printed circuit board (PCB) which mechanically supports and electrically connects electronic components including MCU's using conductive tracks, pads and other features etched from copper sheets laminated onto a non-conductive substrate. PCBs can be single sided (one copper layer), double sided (two copper layers) or multi-layer. Conductors on different layers may be connected with plated-through holes called vias. In further embodiments, a local interface 29 may comprise a printed circuit assembly (PCA), printed circuit board assembly or PCB assembly (PCBA), a circuit card assembly (CCA), or a backplane assembly, or any other suitable electrical connection and communication method including standard wiring and the like.

The controller 21 may be a microcontroller which incorporates a timer module 22 and a memory 23 with the local interface 29. In some embodiments, the controller 21 may be operable to cause the display output 13 to display advisory data, such as pre-loaded or manufacturer installed advisory data and/or user entered advisory data in response to touch input received by a TAPS sensor 28 and/or in response to tilt input received by a tilt sensor 24. In some embodiments, the controller 21 may be operable to enter touch input received by a TAPS sensor 28 and/or to enter tilt input received by a tilt sensor 24 as time data into memory 23. In some further embodiments, the controller 21 may communicate advisory data and/or time data with another electronic device through a wired connection such as through a USB type connector control input 12, and/or through a wireless network, such as by the radio module 26. In even further embodiments, the controller 21 may send time data and/or advisory data to one or more memory chips in wired connection with a user control input 12, such as a USB type or the like memory drive, and this data may then be extracted to cloud storage via wireless communication and/or through the wired, preferably USB type, connection. In still further embodiments, the controller 21 may be operable to enter a change in the orientation of the housing 11, forming tilt input, in a first axis and/or second axis detected by a tilt sensor 28 as time data into memory 23. Example axes are shown in FIGS. 1 and 2. A first axis may be in any direction that is different from any other axis. The axes are not required to be perpendicular to each other as the x-axis, y-axis, and z-axis are commonly portrayed. The only requirement is that a first axis, second axis, third axis, and so on be different from each other. In further embodiments, the controller 21 may be operable to cause the display output 13 to display advisory data in response a change in the orientation of the housing 11, forming tilt input, in a second axis detected by a tilt sensor 24.

The memory 23 may be used by the controller 21 for the storage and retrieval of data, such as time data and advisory data. Time data may include one or more time periods which may be counted down, such as 15 minutes, 120 minutes, two days, or any other time period. Time data may also include the current time, time zone, current date, a calendar, and/or the like. Advisory data may include any words, such as ‘Task name’ or ‘Availability message’, indicia, graphics, symbols, or any other visual data which may be reproduced on a display output 13. The timer module 22 may be operable to provide time keeping functions, such as counting down the expiration of one or more time periods and the keeping of the current time and date.

A control input 12 may enable a user to interact with the device 100, such as by allowing the user to control a function of the device 100 or element of the device, allowing the user to enter or retrieve time data into and from the memory 23, and/or allowing the user to enter or retrieve advisory data into and from the memory 23. In some embodiments, a control input 12 may comprise one or more turnable control knobs, depressible button type switches, a key pad, slide type switches, rocker type switches, or any other suitable user input. The user control inputs 19 may also be configured to modulate the illumination intensity and/or illumination color of a display output 13, the sounds and volumes of sounds produced by a speaker 27, or the sound duration period produced by a speaker 27. In further embodiments, a control input 12 may comprise a USB type connector such as a micro-USB or mini-USB. In other embodiments, a control input 12 may comprise a Type A USB connector, a Type B USB connector, a Mini-A USB connector, a Mini-B USB connector, a Micro-A USB connector, a Micro-B USB connector, a Micro-B USB 3.0 connector, a ExtMicro USB connector, a Lightning connector, a 30-pin dock connector, a Pop-Port connector, a Thunderbolt connector, a Firewire connector, a Portable Digital Media Interface (PDMI) connector, a coaxial power connector connector, a barrel connector plug, a concentric barrel connector plug, a tip connector plug, or any other plug, connector, or receptacle capable of electrical communication with an electronic device such as a computer, smartphone, and the like.

In some embodiments, the device 100 may comprise one or more display outputs 13, such as a first display output, a second display output, a third display output, or any number of display outputs, which may be configured to visually output or display information to a user. For example, a display output 13 may be configured to visually indicate time data, such as the current time or the time left in a time period, and to visually indicate advisory data, such as the purpose of the current time period that is being counted down. In further embodiments, a display output 13 may comprise a light emitting device such as a light-emitting diode (LED). In still further embodiments, a display output 13 may comprise a Liquid crystal display (LCD), Light-emitting diode display (LED), Electroluminescent display (ELD), Electronic paper, E Ink, Plasma display panel (PDP), Cathode ray tube display (CRT), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD).

In preferred embodiments, a control input 12 and a display output 13 may be integrated into a single unit such as a touch screen and/or any other device or method which may be configured to provide visual information to a user and optionally to receive input from a user such as a touch screen display. In some embodiments, a touch screen display output 13 may comprise a resistive or capacitive touch screen which may typically comprise four layers: a top polyester coated with a transparent metallic conductive coating on the bottom; an adhesive spacer; a glass layer coated with a transparent metallic conductive coating on the top; and an adhesive layer on the backside of the glass for mounting. When a user touches the surface, the touch screen records the change in the electrical current that flows through the display. In other embodiments, the touch screen display output 13 may be configured with a variety of touch screen technologies that have different methods of sensing touch such as capacitive sensing, surface capacitive touch sensing, surface acoustic wave sensing, projected capacitance sensing, mutual capacitance sensing, self-capacitance sensing, infrared grid sensing, infrared acrylic projection sensing, optical imaging, dispersive signal sensing, acoustic pulse recognition sensing, or any other suitable tactile input that may detect touch input on a display device. A touch screen display output 13 may also comprise a display device such as a Liquid Crystal Display (LCD), a Cathode ray tube (CRT) display, a Field emission display (FED), a Vacuum fluorescent display (VFD), a Surface-conduction electron-emitter display (SED), a thin or thick film electro-luminescence (EL) display, an inorganic or organic light emitting diode (LED, OLED) display, a Plasma display panel (PDP), a gas discharge display (Nixie tube), or any other suitable display for outputting visual information.

In some embodiments, the device 100 may comprise a power source 25 which may provide electrical power to any element of the device 100 that may require electrical power. A power source 25 may comprise a battery, such as a lithium ion battery, nickel cadmium battery, alkaline battery, or any other suitable type of battery, a fuel cell, a capacitor, a super capacitor, or any other type of energy storing and/or electricity releasing device. In further embodiments, a power source 25 may comprise a power cord, such as a USB connector power cord which may be coupled to a USB type control input 12, kinetic or piezo electric battery charging device, a solar cell or photovoltaic cell, and/or inductive charging or wireless power receiver.

An optional radio module 26 may enable wireless communication with an external access device or network through an antenna 30. The radio module 26 may be operable to enter time data and advisory data into the memory 23 and/or to enable control of other elements of the device 100. A radio module 26 may comprise a wireless communication receiver and optionally a wireless communication transmitter. In some embodiments, a radio module 26 may operate with a Bluetooth wireless technology standard using specifications which may be formalized by the Bluetooth Special Interest Group (SIG) such as Bluetooth v1.0 and v1.0B, Bluetooth v1.1, Bluetooth v1.2, Bluetooth v2.0 +EDR, Bluetooth v2.1+EDR, Bluetooth v3.0 +HS, Bluetooth v4.0, Bluetooth v4.1, Bluetooth v4.2, and Bluetooth v5. Any number of suitable wireless data communication protocols, techniques, or methodologies can be supported by the radio module 26, including, without limitation: RF; IrDA (infrared); cellular band protocols; Bluetooth; ZigBee (and other variants of the IEEE 802.15 protocol); IEEE 802.11 (Wi-Fi or any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

In preferred embodiments, the device 100 may comprise a speaker 27 which may be used to produce a plurality of sounds at a plurality of volume levels. A speaker 27 may comprise a buzzer, a piezoelectric sound producing device, a dielectric elastomer sound producing device, a buzzer, a moving coil loudspeaker, an electrostatic loudspeaker, an isodynamic loudspeaker, a piezo-electric loudspeaker, or any other device capable of producing one or more sounds.

A tilt sensor 24 can measure the tilting, in one or more, such as two axes of a reference plane. One way to measure tilt angle with reference to the earth's ground plane or tilt in an axis is to use an accelerometer and in some embodiments a tilt sensor 24 may comprise an accelerometer. In some embodiments, a tilt sensor 24 may be configured to measure and detect alignment of 2-dimensional plane tilt angles and may include a dual-axis tilt sensors such as 2-axis tilt sensors/ inclinometers utilizing MEMS tilt sensors which are capable of simultaneous 2-axis high accuracy (typically) 0.001° and wide angle measuring range (e.g.)±30.000° . The 2-axis tilt sensor technology enables simultaneous 2D (X-Y plane) tilt angles measurement which traditional single-axis tilt sensors are unable to offer.

One or more tilt sensors 24 may be coupled to or positioned within the housing 11 to detect tilting of the housing 11 in at least one axis and preferably in at least a first axis and a second axis. For example, one or more tilt sensors 24 may be configured to detect the tilting of the housing 11 in a first axis or x-axis (FIG. 1) which may be a front to back tilting and also to detect the tilting of the housing 11 in a second axis or y-axis (FIG. 1) which may be a side to side tilting. The detection of a tilting of the housing 11 and/or the amount or degree of tilting may be communicated to the controller 21 and used to retrieve time data and/or advisory data, to input time data and/or advisory data, and/or to control a function of the device 100 such as time data and/or advisory data which may be displayed on the display output 13.

One or more TAPS sensors 28 may be configured to detect physical contact of a user with all or a portion of the housing 11 as touch input. A TAPS sensor may record the physical contact touch input, such as a touch, bump or certain amount of force applied at a point on a corner, edge or side of the housing 11 by a user. In some embodiments, a TAPS sensor may comprise a capacitance switch, a resistance touch switch, a piezo touch switch, or any other suitable device which is able to detect physical contact of a user with corner, edge or side of the housing 11 as touch input. The detection of a touch input on the housing 11 may be communicated to the controller 21 and used to retrieve time data and/or advisory data, to input time data and/or advisory data, and/or to control a function of the device 100.

In some embodiments, the device 100 may comprise one or more Operating Modes which may be initiated and/or maintainer by the controller 21. In further embodiments, the device 100 may comprise at least two operating modes; an Indicator Mode and a Low Power Mode. The default mode may be the Low Power Mode. The device 100 may transition from Low Power mode to Indicator Mode when the device 100 is tilted above a tilt threshold as detected by a tilt sensor 24, such as a TILT of greater than 5 degrees, is detected or when one or more TAPS are detected by a TAPS sensor 28. The device 100 may transition from Indicator Mode to Low Power Mode after a period of time, such as 2 seconds, after countdown reaches zero. In other embodiments, a tilt threshold may be between 1 degree and 90 degrees. In other embodiments, the device 100 may transition from Indicator Mode to Low Power Mode after a time period of between 0.5 seconds and 10 seconds.

In some embodiments, the device 100 may comprise an Indicator Mode. The purpose of the indicator mode may be to display a countdown and a brief explanatory message 17 (FIGS. 1 and 2), on the display output 13 explaining or describing purpose of the countdown of a time period. While in the indicator mode the display output 13 may display time continuously while in the indicator mode the device 100 may turn on a backlight or other illumination of the display output 13.

In some embodiments, the device 100 may be configured to perform a countdown of a time period. The countdown may be displayed as HH:MM:SS where HH is the number of hours remaining, MM minutes and SS seconds remaining. In other embodiments, the countdown may be displayed in any other format on the display output 13. In some embodiments, the maximum time may be 24:00:00 and the minimum time may be 00:00:00. In further embodiments, the countdown may decrement every 1 second with an accuracy of +/−.001 seconds. In further embodiments, cumulative error in 24 hours preferably may not to exceed 5 seconds. In further embodiments, the countdown may begin 1 second after less than 5 degrees of TILT is detected in any direction and TAPS by the user have stopped. The countdown may progress from the set time to zero in 1 second decrements or any other decrements. When the countdown reaches 00:00:00 the display output 13 may flash on/off at 3 Hz for 2 seconds or any other hertz or time period. In further embodiments, if the advisory data comprises an explanatory message 17 such as “WILL BEEP IN” then the speaker 27 may sound the explanatory message 17 (such as by a voice saying “WILL BEEP IN”) for 1 second or other time period. After completing these two functions the device 100 may enter low power mode.

In some embodiments, the device 100 may be configured to perform a Set Time function. The time that the device 100 may be set to before counting down may be selected in one or more ways, such as through a control input 12, touch screen type display output 13, TILT input, and/or touch input. In some embodiments, TILT input may comprise a difference of angle on corner, edge or side of the housing 11 and be detected by a tilt sensor 24. In some embodiments, touch input may comprise of a touch, bump or certain amount of force applied at a point on a corner, edge or side of the housing 11 and be detected by a TAPS sensor 28. In further embodiments, functionalities such as set time can be operated via a GUI interface on an electronic device to which the device 100 is in electronic communication with such as which may be provided by a USB type connector control input 12. This operation may require the device 100 to be connected to the electronic device or computer or accessed through a wireless network, using the radio module 26, with a successful installation of native GUI or software Application developed specifically for the device 100.

In some embodiments, the device 100 may be configured to receive time data as a set time function and the time data may be received as TILT input or through a wireless and/or USB type connector control input 12 connected GUI interface. The device 100 may be configured to set any time between 00:01:00 and 24:00:00 or any other specified time parameters. The default time may be 00:00:00. Tilting the device 100 in a first axis or direction of an axis, such as left, may increment the number displayed in the countdown on the display output 13. Tilting the device 100 in a second axis or direction of an axis, such as right, may decrement the number displayed in the countdown on the display output 13. In other embodiments, other directions and degrees of tilt may be used to control the countdown. In further embodiments, the greater the angle of tilt the faster the increment or decrement. Once the device 100 is returned to the neutral position (such as less than 5 degree tilt in any direction), preferably as supported by one or more support surfaces 14, the device 100 may begin a timer and the countdown may begin at the end of which advisory data, such as an explanatory message 17 (FIGS. 1 and 2), may be displayed on the display output 13. The device 100 may also be configured through different screens in the GUI to set time in HH:MM:SS format, where in HH is Hours; MM is minutes; SS is seconds. This operation may be performed by connecting the device 100 to an electronic device running the GUI, such as through a USB type connector control input 12, or accessed through a wireless network, such as by the radio module 26, with a successful installation of native GUI or mobile Application developed for use by the device 100.

In some embodiments, the device 100 may be configured to display advisory data, such as an explanatory message 17, on the display output 13. For example, as the user is looking at the display output 13, tilting forward or backward may change advisory data displayed as an explanatory message 17 at the rate of 1 message per second moving through a preset list up or down based on backward or forward tilt respectively. The user may also type in advisory data, such as an explanatory message 17, through the GUI when the device 100 is connected to a computer or other electronic device 100, such as through a control input 12 which may be a USB type connector control input 12, or through a wireless network, such as by the radio module 26. This operation may be performed by connecting the device 100 to the electronic device or accessed through a wireless network via the radio module 26 with a successful installation of native GUI or software Application developed for use by the device 100.

In some embodiments, the device 100 may be configured to receive time data as a set time function and the time data may be received as touch input or through the GUI. In further embodiments, a user may select a pre-determined set time and explanatory message 17 when any of the four bottom corners of the device 100 are tapped to provide touch input. In further embodiments, the determination of which corner or area is tapped is as the user is looking at the display output 13. The user may also set times and save them as favorites, where in user has a quick access to frequently used time slots. For example the user may like to setup the device 100 to frequently count down a time period of 30 minutes, this may be saved as a favorite and accessible through the display output 13 or through the GUI. This operation may be performed by connecting the device 100 the electronic device with a USB type connector control input 12, or accessed through a wireless network via the radio module 26 with a successful installation of native GUI or software Application for use with the device 100.

In some embodiments, the device 100 may comprise a Low Power Mode. In Low Power Mode the device 100 may monitor for TILT input and touch input. The device 100 may have the display output 13 dimmed, turned off, powered down, and/or with a backlight off.

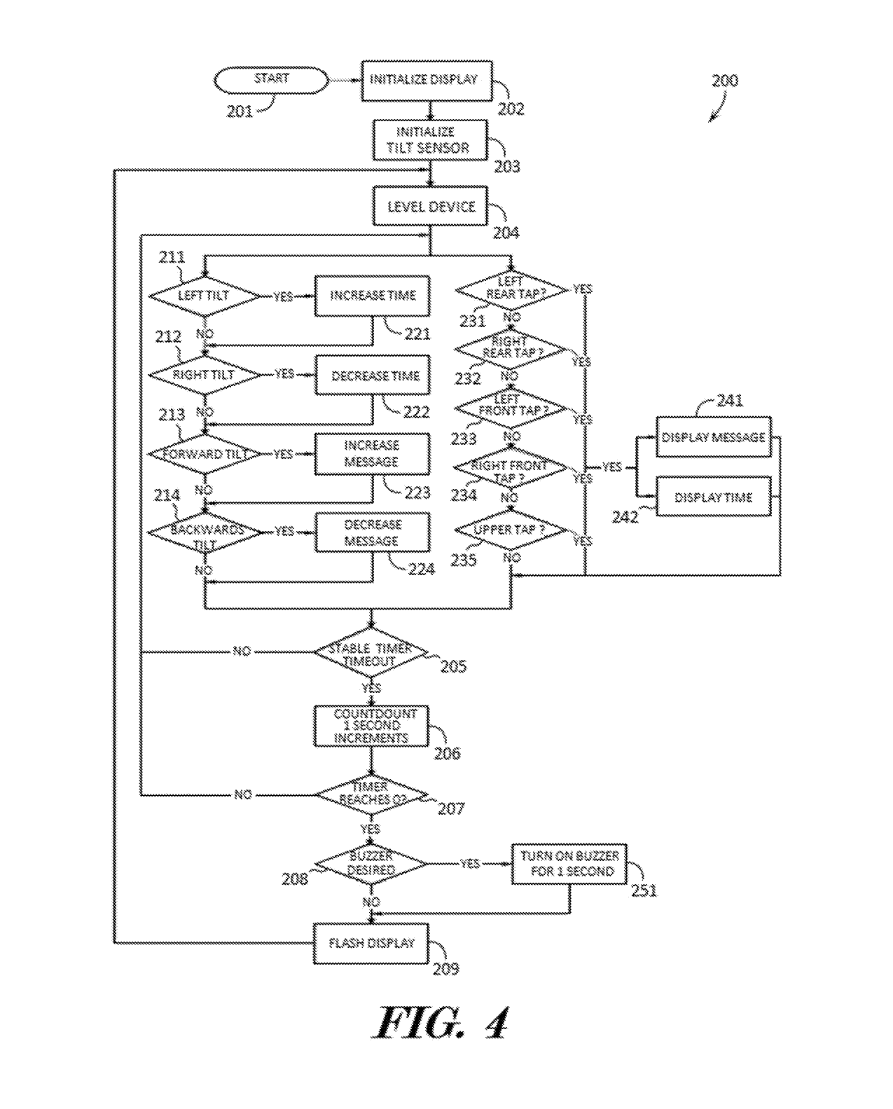

FIG. 4 depicts a flow chart showing an example of a logic sequence used by an advisory time keeping device (“the sequence”) 200 according to various embodiments described herein. In some embodiments, the sequence 200 may start 201 with the initialization of the display output 13 in step 202 and the initialization of the tilt sensor in step 203, and/or the other elements of the device 100. Next the device 100 may be leveled in step 204, such as by placing the device 100 on a level surface, generally perpendicular to the force of gravity, supported by one or more support surfaces 14. Preferably, once the device 100 is supported by one or more support surfaces 14, any departure from level by the device 100 may be detected by one or more tilt sensors 24.

In some embodiments, time data and/or advisory data may be input and retrieved from the device 100 by a user manipulating the device 100. This manipulation may include tilt input, which may be provided by tilting the housing 11 of the device 100, and/or touch input, which may be provided by touching, tapping, bumping, or otherwise applying an amount of force to a point on a corner, edge, or side surface of the housing 11. Tilt input and touch input may be provided at any time in the sequence 200 independently from each other.

As show in steps 211, 212, 213, 214, in some embodiments, tilt input may be provided by a user tilting the housing to the right, to the left, forwards, and/or backwards. In preferred embodiments, the tilting of the housing 11 may be detected by one or more tilt sensors 24 thereby allowing the detection of a change in the orientation of the housing in a first axis, such as right to left, and/or in a second axis, such as forwards and backwards. In the example of FIG. 4, a tilt of the housing 11 in a first axis to the left 211 may be received by the controller 21 and used to increase the amount of time 221 in a period to be counted down by the device 100. A tilt of the housing 11 in a first axis to the right 212 may be received by the controller 21 and used to decrease the amount of time 222 in a period to be counted down by the device 100. A tilt of the housing 11 forwards 213 in a second axis may be received by the controller 21 and used to increase or scroll forward 223 through one or more explanatory messages 17 (FIGS. 1 and 2) comprising advisory data which may be displayed by the device 100. A tilt of the housing 11 backwards 214 in a second axis may be received by the controller 21 and used to decrease or scroll backwards 224 through one or more explanatory messages 17 comprising advisory data which may be displayed by the device 100. It should be understood that the illustrated directions and results of tilting the housing 11 are only examples and that the results of tilting the housing 11 in any direction may be changed or modified without changing the scope of the invention.

As show in steps 231, 232, 233, 234, 235, in some embodiments, touch input may be provided by a user touching, such as by tapping, bumping, or otherwise applying an amount of force to a point on a corner, edge, or side surface of the housing 11. In preferred embodiments, the touching of the housing 11 may be detected by one or more TAPS sensors 28 thereby allowing the detection of tapping, bumping, or otherwise applying an amount of force to one or more points on a corner, edges, or side surfaces of the housing 11. In the example of FIG. 4 the touch input may be provided by a user tapping on one or four upper corners of the housing 11 which may be on the side of the housing 11 opposite the support surfaces 14. Continuing the example, a tap by the user to the left rear corner 231, to the right rear corner 232, to the left front corner 233, to the right front corner 234, and/or to the top or upper surface 235 may result in the display 241 of an explanatory message 17, such as selected in steps 213, 214, and also in the display of time data 242, such as the amount of time in a time period or the time remaining in a time period, such as selected in steps 211, 212, on the display output 13 of the device 100. It should be understood that the illustrated tapping type touch input and location of tapping the housing 11 are only examples and that the results of providing touch input in any location on the housing 11 may be changed or modified without changing the scope of the invention.

In some embodiments, a user may tap the top or upper surface 235 of the device 100 to start, stop, reset, and/or otherwise control a count-up timer which may result in the count-up timer data being displayed by the device 100 as the display of time data 242. A count-up timer function may indicate or be used to track the accumulation of time in a timer period.

In some embodiments, a user may tap the top or upper surface 235 of the device 100 to start, stop, reset, and/or otherwise control a stop watch timer which may result in the stop watch timer data being displayed by the device 100 as the display of time data 242. A stop watch timer function may indicate or be used to generally track the accumulation of time which may or may not be associated with a timer period.

In alternative embodiments, touch input provided by a user to a certain point on a corner, edge, or side surface of the housing 11 may result in the display 241 of one or more explanatory messages 17 and/or the display of one or more types of time data 242 on the display output 13 of the device 100. In further alternative embodiments, tilt input may result in the display 241 of one or more explanatory messages 17 and/or the display of one or more types of time data 242 on the display output 13 of the device 100. In still further alternative embodiments, touch input may be used to provide time data input (steps 221, 222) and/or to provide advisory data input or select advisory data (steps 223, 224).

In block 205, the one or more tilt sensors 24 may determine if the device 100 is stable (maintained in a or level orientation and no touch input) as the selected time period is timed out or counted down. If the device 100 is not stable, the sequence 200 may continue to steps 211 and/or 231. If the device 100 is stable, an incremental countdown 206 of the selected time period may be displayed on the display output 13. In this example, the countdown may be displayed in one second increments although any other increment may be used. In some embodiments, the countdown may be displayed as a graphical countdown representation 15 (FIGS. 1 and 2) such as a two tone bar that changes from one color or illumination intensity to another, a circle that changes from one color or illumination intensity to another, or any other style of graphical countdown representation 15 including a hand or line which moves towards the 12 o'clock position on a circle. The timer module 22 may provide time and countdown function which may be communicated to the controller 21 which in turn may display this information on the display output 13.

In block 207, the timer module 22 and/or controller 21 may determine if the time period has expired, such as the time remaining reaches zero. If the time period has not expired, the device 100 may continue to monitor for tilt and touch input in steps 211, 212, 213, 214, 231, 232, 233, 234, 235. If the time period has expired, the controller 21 may motivate the speaker 27 to turn on or play a buzzer, beeper, or any other sound 251, such as for an exemplary period of one second, if the audio buzzer or other sound was desired and selected in step 208. If no sound was selected, the controller 21 may cause the display output 13 to provide a visual indication that the time has expired, such as by flashing 209 one or more portions of the display output 13. After step 209, the sequence 200 may continue to step 204 and the sequence may continue until the device 100 power is automatically shut off.

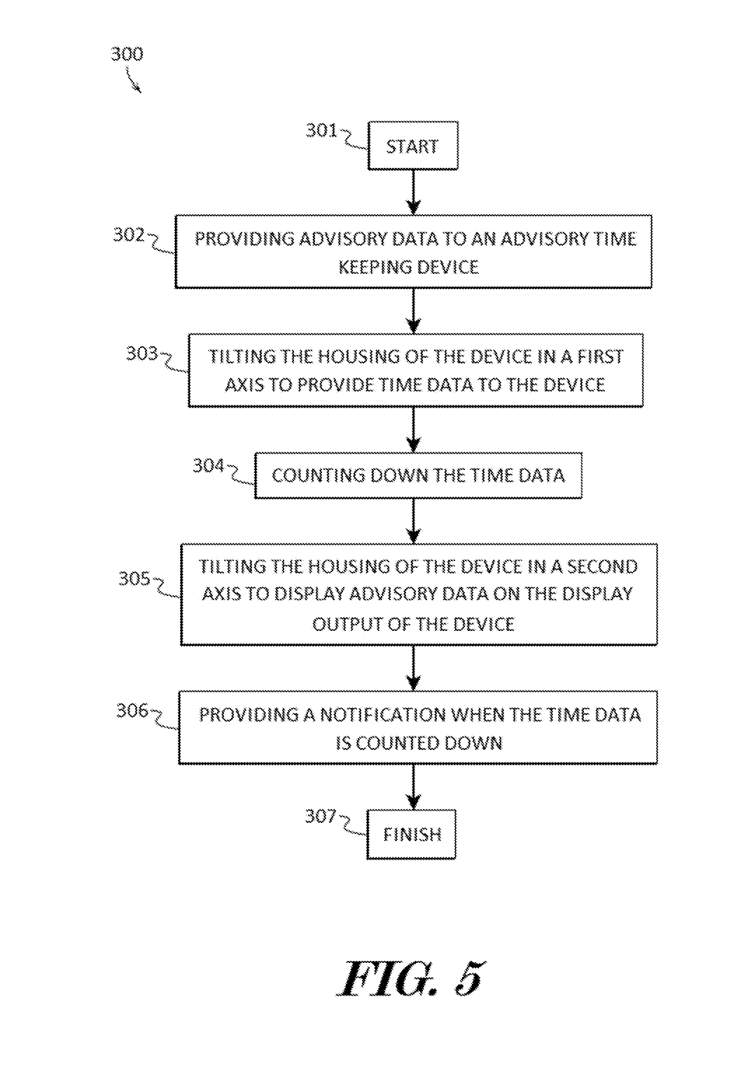

FIG. 5 illustrates a block diagram of an example of a method of providing advisory time keeping (“the method”) 300 according to various embodiments described herein. The method 300 may be used to countdown a time period and to provide advisory data to a user of an advisory time keeping device 100.

In some embodiments, the method 300 may start 301 and advisory data may be provided to an advisory time keeping device 100 in step 302. The advisory data, which may be stored in the memory 23 of a controller 21, may include one or more explanatory messages 17 (FIGS. 1 and 2) which may be displayed on a display output 13. For example, the advisory data may include the explanatory message 17 of “Will Return In” or “Do Not Disturb For”. In further embodiments, the advisory data may be provided by providing tilt input as detected by a tilt sensor 24 and/or provided by providing Touch input as detected by a TAPS sensor 28. In still further embodiments, advisory data may be provided by a default or last selected advisory data that is used as the provided advisory data.

Next in step 303, the housing 11 of the device 100 may be tilted in a first axis to provide time data. A tilt sensor 24 may detect the tilting of the device 100 as tilt input which may be communicated to the controller 21 and stored in memory 23 as time data. A first axis can be any axis, such as an x-axis or a y-axis (FIGS. 1 and 2), so long as it is different than a second axis. For example, time data may be provided to the device 100 as the housing 11 is tilted to the right in a first axis to increase the time period that is to be counted down by the time module 22, and as the housing 11 is tilted to the left in the first axis to decrease the time period that is to be counted down by the time module 22. In another example, time data may be provided to the device 100 as the housing 11 is tilted to forwards in a first axis to increase the time period that is to be counted down by the time module 22, and as the housing 11 is tilted backwards in the first axis to decrease the time period that is to be counted down by the time module 22.

In step 304, the time data may be counted down by the timer module 22. In some embodiments, a numerical countdown representation 16 (FIGS. 1 and 2) may be displayed on the display output 13 that corresponds to the countdown time. In some embodiments, a graphical countdown representation 15 (FIGS. 1 and 2) may be displayed on the display output 13 that corresponds to the countdown time. The timer module 22 may keep track of the countdown and provide countdown data to the controller 21 which may in turn output the countdown data as a graphical countdown representation 15 and/or a numerical countdown representation 16 on the display output 13.

Next in step 305, which may occur at any time and during any step, such as any time during step 304, the housing 11 of the device 100 may be tilted in a second axis to display advisory data on the display output 13. A tilt sensor 24 may detect the tilting of the device 100 as tilt input which may be communicated to the controller 21 and advisory data stored in memory 23 which is associated or which corresponds to the detected tilting may be retrieved from memory 23 and displayed on the display output 13 by the controller 21. A second axis can be any axis, such as an x-axis or a y-axis, so long as it is different than a first axis. For example, when the device 100 is tilted to the right in a second axis, advisory data comprising the explanatory message of “Will Return In” may be displayed on the display output 13. In another example, when the device 100 is tilted to the left in the second axis, advisory data comprising the explanatory message of “Do Not Disturb For” may be displayed on the display output 13.

Continuing to step 306, notification may be provided by the device 100 when the time data is counted down by the timer module 22. The timer module 22 may communicate countdown data to the controller 21 which may include data indicating that the time period has expired or that the countdown has reached zero. In some embodiments, once the time data is counted down, the controller 21 may motivate the display output 13 to provide a visual notification. For example, once time data comprising a twenty minute time period is counted down, one or more portions of the display output 13 may be flashed or blinked as a visual notification. In some embodiments, once the time data is counted down, the controller 21 may motivate a speaker 27 to provide an audio or audible notification. For example, once time data comprising a twenty minute time period is counted down, a buzzer sound, beeping sound, or any other sound may be emitted by the speaker 27. Once the time data has been counted down and a notification has been provided, the method 300 may finish 307.

While some materials have been provided, in other embodiments, the elements that comprise the device 100 such as the housing 11, optional support surface 14, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An advisory time keeping device, the device comprising:
a housing;
a controller with a timer module and a memory disposed in said housing;
a control input operable to enter time data and advisory data into said memory;
a display output coupled to said housing operable for displaying data from said timer circuit and memory; and
a tilt sensor in communication with the controller, wherein the tilt sensor is operable to detect changes in the orientation of the housing, wherein said controller is operable to cause the display output to display advisory data in response to changes in the orientation of the housing detected by the tilt sensor.

2. The device of claim 1, wherein the display output is a touch screen.

3. The device of claim 1, further comprising a TAPS sensor in communication with the controller, wherein the TAPS sensor is operable to receive touch input.

4. The device of claim 3, wherein said controller is operable to cause the display output to display advisory data in response to touch input received by the TAPS sensor.

5. The device of claim 3, wherein said controller is operable to enter touch input received by the TAPS sensor as time data into said memory.

6. The device of claim 1, wherein the control input is a USB type connector.

7. The device of claim 1, further comprising a radio module, wherein said radio module is operable to enter time data and advisory data into said memory.

8. The device of claim 1, further comprising a speaker

9. The device of claim 1, wherein the tilt sensor is operable to detect a change in the orientation of the housing in a first axis, and wherein the tilt sensor is operable to detect a change in the orientation of the housing in a second axis.

10. The device of claim 9, wherein said controller is operable to enter a change in the orientation of the housing in the first axis detected by the tilt sensor as time data into said memory.

11. The device of claim 9, wherein said controller is operable to cause the display output to display advisory data in response a change in the orientation of the housing in the second axis detected by the tilt sensor.

12. A method of providing advisory time keeping, the method comprising the steps of:
providing advisory data to an advisory time keeping device, said device comprising a housing, a controller with a timer module and a memory disposed in said housing, a control input operable to enter time data and advisory data into said memory, a display output coupled to said housing operable for displaying data from said timer circuit and memory, and a tilt sensor in communication with the controller, wherein the tilt sensor is operable to detect changes in the orientation of the housing in a first axis and a second axis, wherein said controller is operable to cause the display output to display advisory data in response to changes in the orientation of the housing detected by the tilt sensor;
tilting the housing of said device in a first axis to provide time data to said device;
counting down the time data with the timer module;
tilting the housing of said device in a second axis to display advisory data on the display output of said device; and
providing a visual notification on the display output when the time data is completely counted down.

13. The method of claim 12, wherein the display output is a touch screen.

14. The method of claim 12, wherein the device further comprises a TAPS sensor in communication with the controller, wherein the TAPS sensor is operable to receive touch input.

15. The method of claim 14, wherein said controller is operable to cause the display output to display advisory data in response to touch input received by the TAPS sensor.

16. The method of claim 14, wherein said controller is operable to enter touch input received by the TAPS sensor as time data into said memory.

17. The method of claim 12, wherein the control input is a USB type connector.

18. The method of claim 12, wherein the device further comprises a radio module, wherein said radio module is operable to enter time data and advisory data into said memory.

19. The method of claim 12, wherein the device further comprises a speaker, wherein said controller is operable to cause the speaker to output advisory data when the tilt sensor detects a change in the orientation of the housing.

20. The method of claim 12, wherein the device further comprises a speaker, wherein said controller is operable to cause the speaker to output an audible notification when the time data is completely counted down.
